(19) United States
(12) Patent Application Publication
(10) Pub. No.: US 2013/0271258 A1
(43) Pub. Date: Oct. 17, 2013

(54) TEMPERATURE-DEPENDENT SWITCH WITH CONTACT PART AS HEATING RESISTOR

(71) Applicant: THERMIK GERAETEBAU GMBH, Sondershausen (DE)

(72) Inventors: Marcel P. HOFSAESS, SONDERSHAUSEN (DE); Lutz BUETTNER, SONDERSHAUSEN (DE)

(21) Appl. No.: 13/857,162

(22) Filed: Apr. 5, 2013

(30) Foreign Application Priority Data
Apr. 17, 2012 (DE) 10 2012 103 306.4

(51) Int. Cl. H01H 37/64

(52) U.S. Cl. CPC H01H 37/64
USPC 337/298

(57) ABSTRACT

A temperature-dependent switch has a temperature-dependent switching mechanism, which, depending on its temperature, opens or closes at least one switching contact, which is formed by two contact parts that are in contact with each other via their switching areas when the switch is closed. At least one contact part has a body made of resistance material and a top layer made of contact material and forming its switching area.

### CROSS-REFERENCE TO RELATED APPLICATION

This application claims priority to German patent application DE 10 2012 103 306, filed Apr. 17, 2012, which is incorporated herein by reference.

### BACKGROUND OF THE INVENTION

The present invention relates to a temperature-dependent switch with a temperature-dependent switching mechanism, which, depending on its temperature, opens or closes at least one switching contact, which is formed by two contact parts that are in contact with each other via their switching areas when the switch is closed, one of the contact parts being formed as a heating resistor and consisting at least partially of resistance material.

A switch of this type is known from DE 195 45 998 C2.

The known switch serves in a way known per se for monitoring the temperature of a device. For this purpose, it is brought into thermal contact with the device to be protected, so that the temperature of the protected device influences the temperature of the switching mechanism.

The switch is also connected by way of its external terminals electrically in series into the supply circuit of the device to be protected, so that below the response temperature of the switch the supply current for the device to be protected flows through the switch.

If the temperature of the device to be protected increases beyond the response temperature of the switch, the switch switches from its low-temperature position into its high-temperature position, whereby the switching contact is being opened, so that the circuit to the device to be protected is interrupted.

If the temperature of the device to be protected, and consequently the temperature of the switch, falls again below the response temperature of the temperature-dependent switching mechanism, the switch closes again, which is undesired in particular whenever the cause for the temperature increase has not yet been eliminated at the device to be protected.

In order to avoid these recurring on and off cycles, DE 195 45 998 C2 proposes in a way known per se providing parallel to the external terminals, that is to say parallel to the temperature-dependent switching mechanism, a so-called self-holding resistor, which is short-circuited by the switching mechanism when the switch is closed but lies in series in the supply circuit for the device to be protected when the switch is open.

This parallel resistor has such a resistance value that only a small current still flows through the device to be protected, but is sufficient to generate so much resistive heat in the switch that the temperature-dependent switching mechanism is kept at a temperature above its response temperature or switching-back temperature.

Only when the supply circuit is actively interrupted can the known switch cool down to the extent that it can close again.

Also additionally provided in the case of the known switching mechanism is a heating resistor, which is connected in series with the temperature-dependent switching mechanism, so that the operating current of the device to be protected that is flowing when the switch is closed also flows through this heating resistor and correspondingly heats it up.

The resistance value of the heating resistor is in this case set such that the resistive heat produced in the heating resistor when there is a maximum admissible operating current does not yet have the effect that the response temperature of the switching mechanism is exceeded, but a current flow that typically corresponds to at least three times the maximum admissible operating current has the effect that the switch opens.

The known switch has a cup-like lower part, provided in which is a peripheral shoulder, on which a cover part rests with an insulating layer interposed and is held on the shoulder by a flanged rim of the lower part.

Arranged in the housing formed in this way is a temperature-dependent switching mechanism, which comprises a snap-acting spring disc, which bears a movable contact part which interacts with a stationary contact part which is arranged centrally in the cover part.

Arranged between the cover part and the snap-acting spring disc is a bimetallic disc, which is fitted over the movable contact part.

In the low-temperature position, the snap-acting spring disc presses the movable contact part against the stationary contact part, so that the switching contact thereby formed is closed. In this switching position, the bimetallic disc rests loosely on the snap-acting spring disc, the current flows from the stationary contact part into the movable contact part, from the latter into the snap-acting spring disc and from the latter over its rim into the lower part consisting of metal.

If the temperature of the bimetallic disc then increases above its response temperature, it snaps over into its high-temperature configuration, in which it is supported by its rim against the inside of the cover part and, by its center, pushes the movable contact part away from the stationary contact against the force of the snap-acting spring disc.

In the case of the known switch, the movable contact part is produced from a resistance material such as constantan, so that the movable contact part acts as a heating resistor, because it is of course connected electrically in series with the temperature-dependent switching mechanism in the supply circuit when the switch is closed.

Simultaneously using the movable contact part also as a heating resistor has the advantage that the resistive heat produced in the heating resistor by the operating current flowing is generated in the direct proximity of the bimetallic disc, so that the known switch opens quickly when the operating current exceeds the admissible value, which is determined in particular by the resistance value of the contact part.

In order to prevent closing of the known switch after the device to be protected has cooled down, it is provided with a self-holding resistor, which is formed on the cover part, in one embodiment the cover part also itself being formed as a PTC resistor.

Although the known switch meets modern requirements with respect to functionality and response, tests conducted by the applicant have shown that operational reliability is often not maintained in long-term operation.

### SUMMARY OF THE INVENTION

In view of the above, it is one object of the present invention to further develop the known switch in such a way that it still opens and closes reliably even in the case of a long operating period and a high number of switching cycles in a structurally simple way and without the rapid response being significantly impaired.

This and other objects are achieved according to the invention in the case of the switch mentioned at the outset in that the contact part that is formed as a heating resistor comprises a body that comprises the resistance material and has a top layer of contact material on its switching area.

This is so because the inventors of the present application have recognized that one problem with the known switch is that the contact resistance at the switching areas of the two contact parts increases in the course of the switching cycles, which occurs for example due to corrosion. The inventors have also identified another problem with the known switch as being that the formation of arcs during the opening of the switch is not sufficiently prevented, so that the switching areas as it were stick together and the movable contact part is not detached from the stationary contact part, or not quickly enough.

Furthermore, the resistance-determining geometry of the movable contact part changes due to wearing of the contact part, for example as a result of contact erosion.

These problems increase with the number of switching cycles, so that the response of the known switch to high switching currents and the level of the currents at which the known switch opens deteriorate over time.

The inventors of the present application have recognized that the reason for this lies with the constantan proposed as resistance material for the movable contact part, which does not have the required properties possessed by other metal alloys or metals typically used as contact material.

It is therefore envisaged according to the invention to provide the contact part with a body which consists of a resistance material and defines the heating resistance, while the switching area of the switching contact is provided with a top layer of typical contact material that has an appropriately great conductivity, and therefore only insignificantly influences the resistance value of the contact part thus improved.

The inventors of the present application have recognized here that it is important to provide the switching area with a material which is soft in the hot state, so that the contacts can become detached quickly. This is not ensured by the resistance material that is used according to the invention for the body, but is by a top layer of typical contact material.

Within the scope of the present invention, a resistance material is understood as meaning a metal or metal alloy that has a much lower conductivity, preferably at least 10 times lower conductivity, than the contact material used as the top layer, so that the value of the heating resistance is determined by the body of resistance material, that is to say its geometry, and by the choice of the resistance material itself.

According to one object, the resistance material has an electrical conductivity <10% IACS, and, according to a further object, the contact material has an electrical conductivity >50% IACS, preferably a conductivity that is at least 10 times higher than that of the resistance material.

IACS is a unit that is commonly used in the US in particular for the conductivity of resistance materials. It expresses the conductivity as a percentage of the conductivity of pure annealed copper (IACS: International Annealed Copper Standard). 100% IACS thereby corresponds to 58 MS/m, that is to say 58 megasiemens per meter.

Resistance materials with an electrical conductivity <10% IACS are, for example, constantan (55% copper, 44% nickel, 1% manganese), which has a conductivity of 3.5% IACS, and for example ISA Chrom 60 (15% chromium, 20% iron, 65% nickel), which has a conductivity of 1.54% IACS.

Materials that are typically used for stationary and movable contact parts are used as the contact material, it being possible for the top layer for example to be laminated or cold-stamped onto the body.

Suitable contact materials are, for example, AgW55 (45% silver, 55% tungsten) with 58% IACS, CuW60 (40% copper, 60% tungsten) with 52% IACS, CuZr with 95% IACS, and many other suitable copper and silver alloys.

Measurements conducted by the applicant have shown that such a contact part with a body of resistance material and a top layer of contact material has a resistance value in the range of 1-20 mΩ both in the cold state and in the state in which it has been heated by the flow of current. This is much higher than the resistance value that is usually encountered in the case of switching contacts of contact material, which under measuring conditions typical for the application, including the contact resistance between the two closed contact parts, lies in the range of 0.7 mΩ.

Compared with an external heating resistor that is attached to the outside of the housing of a temperature-dependent switch, the response time to excess current increases by more than a factor of 10. Measured response times with an operating current of 20 A D/C lay in the range of 500 msec, while the applicant's switches of the type SZ5 with an external heating resistor have response times in the range of 20 sec.

The inventors of the present application have recognized that the switch provided with the novel contact part has a long-term stability such as that also achieved in the case of switches without resistance material in the body of the contact part.

The top layer of contact material changes during the switching cycles, it can as it were be regarded as a consumable layer, while the body of resistance material is not impaired even by many switching cycles, so that there is no wearing of the resistance-determining geometry, for which reason the resistance value of the contact part does not change over time, which conversely means that the low response time is retained.

The top layer is in this case laminated on with a thickness of at least 100 μm, which represents a sufficient thickness of the “consumable layer” to withstand many 100s to several 1000s of switching cycles, depending on the specific application.

Furthermore, the parameters that are relevant for the classification of the temperature-dependent switch, such as the response temperature, the switching-back temperature, the response current, etc., vary during the envisaged service life within the ranges in which the parameters of the applicant's switches that are provided with a customary contact part of contact material also vary.

In one embodiment, both contact parts are formed as a heating resistor. According to one object, one of the two contact parts is a movable contact part, which is arranged or formed on the temperature-dependent switching mechanism, while the other of the two contact parts may be a stationary contact part, which is arranged or formed on a housing part of the switch.

Temperature-dependent switches are provided in various types of design. The switching mechanism thereby comprises a spring part, which bears or comprises the movable contact part. The spring part may be produced from bimetallic material or resilient material. High-quality switches have a temperature-dependent switching mechanism with a snap-acting spring disc and a bimetallic disc, the movable contact part establishing electrical contact with the snap-acting spring disc. This movable contact part operates together with a stationary contact part, which is generally arranged centrally in the cover of the switch.

However, it is also possible to provide instead of the snap-acting spring disc a resilient tongue, which is restrained at one end and bears the movable contact part at its free end. Here, too, it is possible to use resilient material and bimetallic material in order to relieve the bimetallic material of the flow of current.

In this connection, the movable contact part and the stationary contact part may, for example, be provided as separately produced contact parts, which are then attached to the bimetallic part or resilient part of the switching mechanism or an electrode or mating area of the switch. However, it is also possible to form regions of the bimetallic part or spring part of the switching mechanism or of the electrode or mating area of the switch as a contact part, for example by an insert or an intermediate layer of a body of resistance material being arranged at the corresponding location and covered over by a top layer of contact material.

For the case where no heed is to be paid to the loading of the bimetallic material with current, temperature-dependent switching mechanisms in which merely a bimetallic material is used as the resilient part, whether as a bimetallic disc or as a bimetallic tongue, may also be used in a simple case. In this case, current then flows through the bimetallic part itself.

Further, the switch may also have a so-called contact plate or so-called current transfer member, which respectively bears two movable contact parts or on which there are formed two contact parts which respectively interact with a stationary contact part. In this way, the temperature-dependent switch therefore contains two switching contacts, which are opened and closed at the same time.

In a switch of a simple construction, the two movable contact parts may also be arranged or formed on a bimetallic disc or spring that is for example mounted centrally, so that also in the case of this constructional variant the current flows through the bimetallic part.

The external terminals of the switch are connected to the stationary contact parts, while the movable contact parts are electrically connected to one another on the contact plate or on the bimetallic part. These switches are used in particular whenever very high currents are to be switched.

It follows from what has been said above that both the stationary contact parts and the movable contact parts have a contact area to the switch. This contact area may be the bearing area of a stationary or movable contact on the cover part or the spring part, but it is also possible to form the contact parts as rivets, so that they have corresponding contact areas by which they are fastened to the cover part or a resilient part by clamping, pressing or welding.

The body may have at least one contact area in relation to the switch, the contact area having a finished surface.

Within the scope of the present invention, a finished surface is understood as meaning a surface that provides a durable contact in relation to the switch, without the contact resistance being increased as a result of high current flow or mechanical loading.

The contact area may be provided with a metallic coating which has an electrical conductivity >95% IACS, the contact area may further have a surface that is finished by electroplating.

The inventors of the present application have recognized that in this way the contact part formed as a heating resistor can be fastened to the corresponding switch part by riveting or welding, without the contact resistance being increased and without the resistance value of the body changing.

In view of the above, the present invention also relates to a contact part for a temperature-dependent switch, said contact part comprising a body of resistance material, a top layer of contact material on a switching area, and a finished surface on at least one contact area.

As already mentioned above, the resistance material in this case may have an electrical conductivity <10% IACS, while the contact material may have a conductivity that is at least 10 times higher than that of the resistance material.

Contact parts of this type may be used as movable and stationary contact parts in temperature-dependent switches of the widest variety of types.

The contact part does not necessarily have to be a contact part in the form of a block; it may also comprise a region on an electrode in the switch that comprises an insert of resistance material and a top layer of contact material.

Further features and advantages emerge from the description and the accompanying drawing.

It goes without saying that the features mentioned above and still to be explained below can be used not only in the respectively specified combinations but also in other combinations or on their own without departing from the scope of the present invention.

### BRIEF DESCRIPTION OF THE DRAWINGS

Embodiments of the invention are represented in the drawings and are explained in more detail in the description below. In the drawings:

FIG. 1 shows in a schematic side view, not to scale, a temperature-dependent switch in a first embodiment, in which the novel contact parts are used;

FIG. 2 shows an example of a contact part in the switch from FIG. 1, which is formed as a heating resistor;

FIG. 3 shows in a schematic side view a further contact part in the switch from FIG. 1, which is formed as a heating resistor;

FIG. 4 shows in a representation similar to FIG. 1 a further embodiment of a temperature-dependent switch, in which the contact part from FIG. 2 is used; and

FIG. 5 shows in a representation similar to FIG. 1 a further embodiment of a temperature-dependent switch, in which a contact part according to FIG. 2 is used.

### DESCRIPTION OF PREFERRED EMBODIMENTS

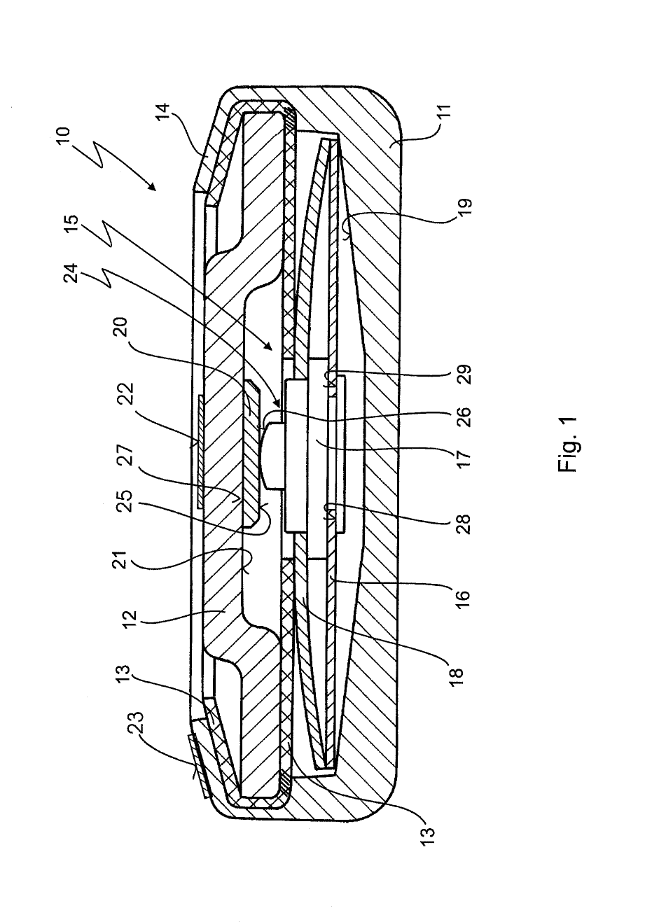

In FIG. 1, 10 denotes a temperature-dependent switch, which has a cup-like lower part 11 of conductive material, on which a cover part 12 of likewise conductive material sits. Provided between the lower part 11 and the cover part 12 is an insulating film 13, which is held on the lower part 11 together with the cover part 12 by a flanged rim 14 of said lower part.

Arranged in the switch 10 is a temperature-dependent switching mechanism 15, which comprises a snap-acting spring disc 16, which bears a movable contact part 17. Placed over the movable contact part 17 is a bimetallic disc 18.

In the closed state of the switch 10, shown in FIG. 1, the resilient snap disc 16 is supported by its rim on a base 19 of the lower part and thereby presses the movable contact part 17 against a stationary contact part 20, which is provided on an inner side 21 of the cover part 12.

A terminal area 22 is provided centrally on the outside of the cover part 12, while a further terminal area 23 is provided on the rim 14.

The stationary contact part 20 and the movable contact part 17 form a switching contact 24, in which the contact part 20 rests by its switching area 25 on a switching area 26 of the contact part 17.

In the closed state, shown in FIG. 1, the supply circuit for a device to be protected is connected to the terminal areas 22 and 23, so that the operating current of the device flows from the terminal area 22 via the cover part 12 into the contact part 20, from the latter into the contact part 17, from the latter into the snap-acting spring disc 16 and from the latter into the lower part 12, which is connected in an electrically conducting manner to the second terminal area 23.

If the temperature inside the switch 10 increases beyond the response temperature of the bimetallic disc 18, the latter snaps over from its convex form, as shown, into a concave form, in which it is supported by its rim against the insulating film 13 and, by its center, thereby lifts the movable contact part 17 off from the stationary contact part 20, so that the switching contact 24 is opened.

If the bimetallic disc 18 comes down to a temperature below its switching-back temperature, the switch 10 closes again.

Decisive for the equivalent resistance of the switching contact, on the one hand side, is the quality of the switching areas 25 and 26, an on the other hand side the contact resistance at a contact area 27 to the cover part 12 and also at two other contact areas 28 and 29 to the snap-acting spring disc 16, as well as the contact resistance of the snap-acting spring disc 16 in relation to the lower part 11.

In the case of a typical switch from the applicant, the contact parts 17 and 20 are produced from a typical contact material with a conductivity of almost 100% IACS. The entire equivalent resistance of the switch 10 between the terminal areas 22, 23 under measuring conditions typical for the application is 2 mΩ, of which approximately 0.7 mΩ is accounted for by the switching contact 25.

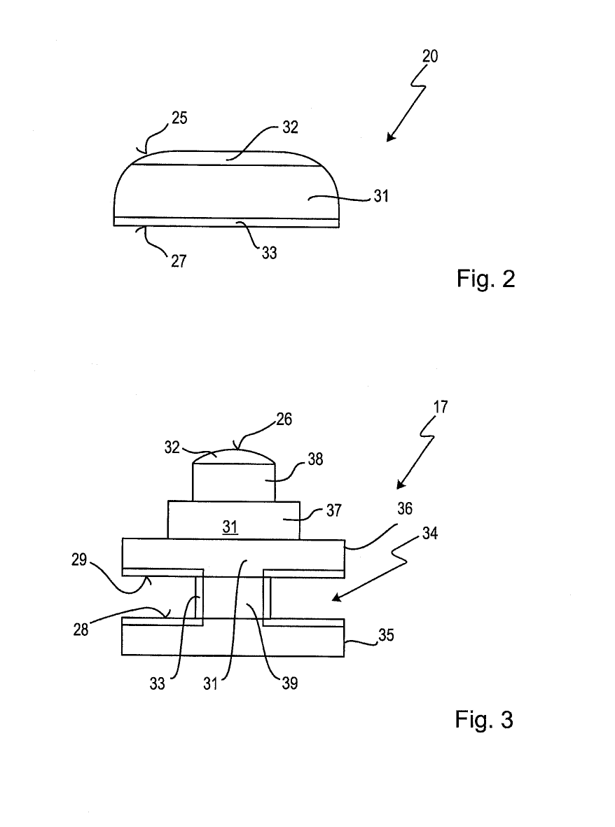

However, in order to provide the switch 10 with a heating resistor which heats up the interior of the switch to a temperature above the response temperature of the bimetallic disc 18 also when a maximum admissible operating current is exceeded, according to the invention the two contact parts 17 and 20 are formed as a heating resistor, as will now be explained with reference to FIGS. 2 and 3.

Shown in FIG. 2 in an enlarged, schematic side view is the stationary contact part 20, which has a body 31 of resistance material with a conductivity <2% IACS, for example consists of ISA Chrom 60.

Arranged on top of the body 31 is a top layer 32 of typical contact material, which has an electrical conductivity of >50% IACS, generally of about 100%. The top layer 32 is laminated onto the body 31.

At the contact area 27 in relation to the cover part 12, the body 31 is provided with a coating 33, which has a finished surface obtained by electroplating.

At the contact area 27, the contact part 20 may be welded or soldered onto an electrode in any desired temperature-dependent switch.

Shown in FIG. 3 in a schematic side view not to scale is the movable contact part 17 from the switch 10 from FIG. 1.

The contact part 17 has a peripheral groove 34 between two discs 35 and 36. Provided above the upper disc 36 is a spacer 37, arranged on which is a contact piece 38, onto which a top layer 32 that forms the switching area 26 has been laminated.

With the peripheral groove 34, the movable contact part 17 sits in the snap-acting spring disc 16, which is not shown in FIG. 3 for reasons of overall clarity.

At the two discs 35 and 36 and at the pin 39 which connects the two discs and around which the groove 34 runs, the contact areas 28, 29 are provided in a way corresponding to the contact part 20 from FIG. 2 with a coating 33, which forms a finished surface by being electroplated.

Thus, by flanging of the pin 39 to form the lower disc 35, the contact part 17 can be riveted onto a resilient disc or some other current-carrying part of a temperature-dependent switch.

As mentioned in detail at the outset, the switching contact 17 also has a body 31 of resistance material.

In the case of the switching contacts 20 from FIGS. 2 and 17 from FIG. 3, the resistance value between the switching area 25 or 26 and the contact area 27 or 28, 29 is determined on the one hand by the geometry of the body 31 and on the other hand by the electrical conductivity of the resistance material in the body 31.

Depending on the geometry, the contact parts 20 and 17 have in each case a resistance value of 1-20 mΩ.

The top layers 32 have in this case a very much lower resistance; it lies well below 1 mΩ. The coating 33 likewise has a high electrical conductivity; its resistance value lies well below 1 mΩ.

In the embodiment shown, the two contact parts 17 and 20 in the switch 10 from FIG. 1 are formed as a heating resistor, although in many cases it is sufficient to form only one contact part 17 or 20 as a heating resistor with a body 31 of resistance material.

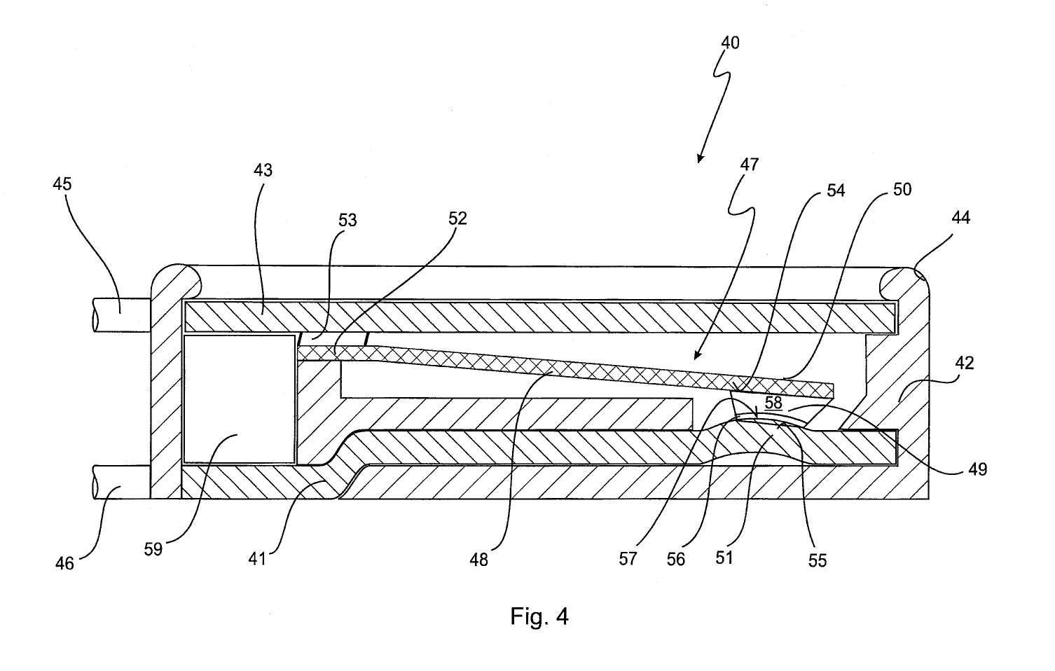

Shown in FIG. 4 is a further embodiment of a temperature-dependent switch 40, in which a contact part as in FIG. 2, which is formed as a heating resistor, can be used.

The switch 10 has a bottom electrode 41, which is encapsulated with a supporting part 42 of plastic, on which there sits a top electrode 43, which is held by way of a hot-pressed rim 44 of the supporting part 42.

The top electrode 43 and the bottom electrode 41 are provided with external terminals 45 and 46, respectively.

Arranged inside the housing thus formed of the switch 10 is a temperature-dependent switching mechanism 47, which in the present case comprises a resilient tongue 48 of bimetallic material.

The resilient tongue 48 bears a movable contact part 49 at its free end 50. The movable contact part 49 operates together with a protrusion 51 of the bottom electrode 41. This protrusion 51 acts as a stationary contact part, so that the contact part 49 and the protrusion form a switching contact.

At its rear end 52, the resilient tongue 48 is connected to the top electrode 43 by way of an intermediate part 53.

As already in the case of the contact part 20 from FIG. 2, the contact part 49 also has a contact area 54 in relation to the resilient tongue 48 and a switching area 55, which is formed by a top layer 56 of contact material.

The switching area 55 operates together with the switching area 57 on the protrusion 51.

Like the switching contact 20 from FIG. 2, the switching contact 49 has a body 58 of resistance material, it also being possible for a region of the protrusion 41 to be formed as resistance material.

If the temperature inside the switch 40 increases beyond the response temperature of the resilient tongue 48, the latter moves its free end 50 upwards in FIG. 4, so that the movable contact part 49 is lifted off from the protrusion 51.

In order that the switch 40 does not close again when there is a reduction in the temperature of the device to be protected, or as a result of the small operating current flowing, said switch has a PTC component 59, which is connected between the top electrode 43 and the bottom electrode 41, so that when the switch 40 is open a residual current flows through the PTC component 59 and keeps the switch 40 at a temperature above the switching temperature of the resilient tongue 48.

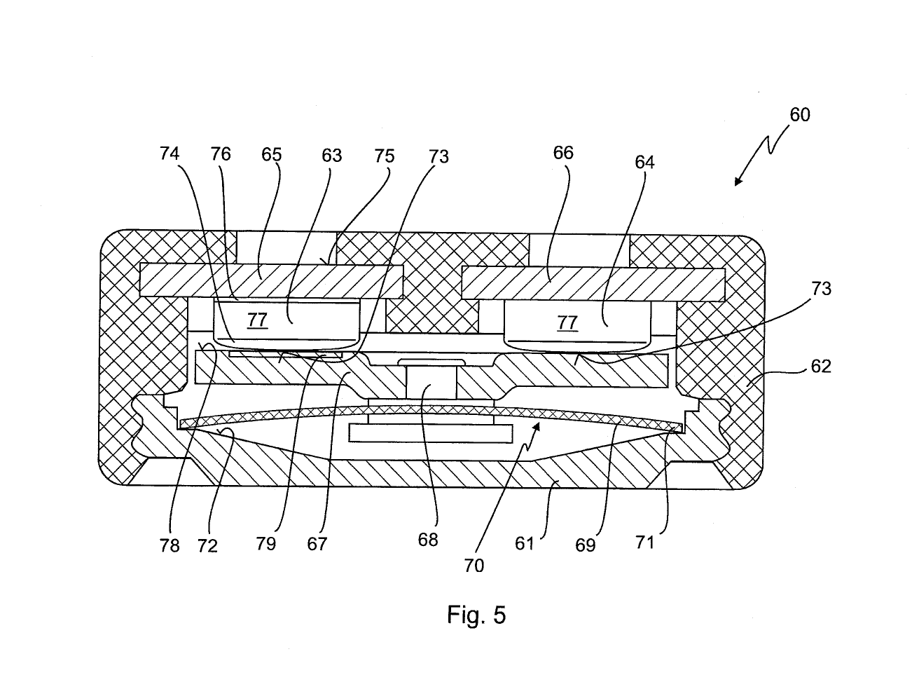

A further switch 60, in which contact parts formed as a heating resistor can be used, is shown in FIG. 5.

The switch 60 from FIG. 5 has a conductive lower part 61, which is closed by a cup-like, insulating cover part 62.

Arranged in the cover part 62 are two stationary contact parts 63 and 64, which interact with external terminals 65 and 66.

The two stationary contact parts 63 and 64 operate together with a contact bridge 67, which is fixed on a resilient disc 69 of bimetallic material by way of a rivet 68. In this way, a temperature-dependent switching mechanism 70 is formed.

The resilient disc 69 is supported by its rim 71 on a base 72 of the lower part 61 and thus pushes the contact bridge 67 against the stationary contacts 63 and 64.

The contact bridge 67 is produced from electrically conductive material, so that in the closed state of the switch 60, shown in FIG. 5, the two stationary contacts 63 and 64 are electrically short-circuited by way of their switching areas 73.

The switching area 73 is again formed by a top layer 74 of contact material, while the stationary contacts 63 and 64, like the contact 20 from FIG. 2, are provided with a contact area 55 in relation to the switch itself, here in relation to the external terminals 65 and 66, on which there is formed a coating 76 produced by electroplating.

Each stationary contact part 63 and 64 again has a body 77 of resistance material, which has an electrical conductivity <2% IACS.

In the closed state of the switch 60, shown in FIG. 5, the stationary contacts 63 and 64 are short-circuited by way of the contact bridge 67, so that the operating current of the device to be protected flows via the external terminal 65, the contact part 63, the contact bridge 67 and the contact part 64 to the external terminal 66.

The operating current in this case therefore also flows through the stationary contact parts 63 and 64, the body 77 of which consists of resistance material, so that the heating resistors thus formed produce inside the switch 60 a resistive heat that is proportional to the square of the operating current flowing.

As soon as the operating current exceeds a maximum admissible value by a predetermined amount, the resistive heat produced has the effect that the resilient disc 69 is heated up to a temperature above its transition temperature, so that it changes its curvature and thereby lifts the contact bridge 67 off from the stationary contacts 63 and 64, so that the switch 60 is opened.

In certain specific applications, the response time of the switches 10, 40 and 60 when the maximum admissible operating current is exceeded by a factor of 3 lies well below one second, the response time not increasing even after many switching cycles because of the “consumable layers” 32, 56 and 74.

In addition, the switches 10, 40 and 60 also respond to an increase in the temperature as a result of an increase in the temperature of the device to be protected itself even when the operating current of the device to be protected remains below the critical value that leads to an increase in the heat emission in the contacts formed as a heating resistor.

It should also be mentioned that switching areas 78 which interact with the switching areas 74 of the stationary contacts 64, 65 are provided on the contact bridge 67. Underneath the switching area 78, a body 79 of resistance material may also be provided on the resistance bridge 74.

Therefore, what is claimed is:

1. A temperature-dependent switch comprising a temperature-dependent switching mechanism and at least two contact parts,
each contact part comprising a switching area, said at least two contact parts forming a switching contact,
said temperature-dependent switching mechanism, depending on its temperature, opening or closing said switching contact, said two contact parts being in contact with each other via their switching areas when the switch is closed,
at least one of said contact parts comprising a body including resistance material and comprising a top layer made of contact material forming its switching area, such that said at least one contact part is formed as a heating resistor.

2. The switch of claim 1, wherein the resistance material has an electrical conductivity below 10% IACS.

3. The switch of claim 2, wherein the contact material has an electrical conductivity above 50% IACS,

4. The switch of claim 1, wherein the contact material has an electrical conductivity that is at least 10 times higher than that of the resistance material.

5. The switch of claim 1, wherein both contact parts comprise each a body including resistance material and comprise each a top layer made of contact material forming a respective switching area,

6. The switch of claim 1, wherein one of the two contact parts is a movable contact part provided on the temperature-dependent switching mechanism.

7. The switch of claim 6, wherein the other of the two contact parts is a stationary contact part, which is provided on a housing part of the switch.

8. The switch of claim 1, wherein the top layer is laminated on the body.

9. The switch of claim 1, wherein the body comprises at least one contact area in mechanical and electrical contact with said switch, said contact area being provided with a finished surface.

10. The switch of claim 9, wherein the contact area is provided with a metallic coating having an electrical conductivity above 95% IACS.

11. The switch of claim 10, wherein the contact area comprises a surface finished by electroplating.

12. The switch of claim 1, comprising two pairs of contact parts, each pair of contact parts including a movable contact part and forming a switching contact, each movable contact part being moved by the temperature-dependent switching mechanism.

13. The switch of claim 12, wherein both movable contact parts are provided on a contact bridge.

14. The switch according of claim 1, wherein the temperature-dependent switching mechanism comprises a resilient part, which is provided with a movable contact part.

15. The switch of claim 14, wherein the resilient part is a snap-acting spring disc, and wherein the temperature-dependent switching mechanism further comprises a bimetallic.

16. A contact part for a temperature-dependent switch, comprising a body of resistance material, a top layer of contact material forming a switching area and a finished surface forming at least one contact area.

17. The contact part of claim 16, wherein the resistance material comprises an electrical conductivity below 10% IACS.

18. The contact part of claim 16, wherein the contact material has an electrical conductivity that is at least 10 times higher than the electrical conductivity of the resistance material.

19. A temperature-dependent switch comprising a temperature-dependent switching mechanism and at least two contact parts,
each contact part comprising a switching area, said at least two contact parts forming a switching contact,
said temperature-dependent switching mechanism, depending on its temperature, opening or closing said switching contact, said two contact parts being in contact with each other via their switching areas when the switch is closed,
at least one of said contact parts comprising a body including resistance material having an electrical conductivity below 10% IACS, and a top layer made of contact material having an electrical conductivity that is at least 10 times higher than that of the resistance material, said top layer forming said switching area of said at least one contact part,
wherein the body further comprises at least one contact area in mechanical and electrical contact with said switch, said contact area being provided with a metallic coating having an electrical conductivity above 95% IACS.
